(19) United States
(12) Patent Application Publication
(10) Pub. No.: US 2025/0083861 A1
(43) Pub. Date: Mar. 13, 2025

(54) STACKABLE CARTON WITH RETRACTABLE HANDLE AND BLANK AND METHOD FOR FORMING THE SAME

(71) Applicant: WestRock Packaging Systems, LLC, Atlanta, GA (US)

(72) Inventor: Sylvain VACHON, Quebec (CA)

(21) Appl. No.: 18/726,714

(22) PCT Filed: Jan. 5, 2023
(86) PCT No.: PCT/US2023/010226

§ 371 Date: Jul. 3, 2024

Related U.S. Application Data
(60) Provisional application No. 63/296,979, filed on Jan. 6, 2022.

(51) Int. Cl. B65D 5/46; B31B 50/26; B31B 50/73; B31B 50/86; B31B 100/00; B31B 110/35; B31B 120/40; B31B 120/50; B65B 43/26; B65D 5/10; B65D 5/42; B65D 5/56; B65D 5/62

(52) U.S. Cl. CPC B65D 5/46096; B31B 50/262; B31B 50/734; B31B 50/86; B65B 43/265; B65D 5/106; B65D 5/4212; B65D 5/56; B65D 5/62; B31B 2100/0022; B31B 2110/35; B31B 2120/40; B31B 2120/50

(57) ABSTRACT

A carton for packaging product includes a bottom wall, a plurality of side walls connected to the bottom wall, a top wall connected to the side walls, and a handle connected to the top wall and movable relative to the top wall between a retracted configuration and a deployed configuration. At least a portion of the top wall forms a planar surface. In the retracted configuration, the handle is in a coplanar relationship with the planar surface. In the deployed configuration, the handle is in a non-coplanar relationship with the planar surface.

### CROSS-REFERENCE TO RELATED APPLICATIONS

This application claims priority to and the benefit of U.S. Provisional Application No. 63/296,979, filed Jan. 6, 2022, the entire contents of each are herein incorporated by reference in their entirety.

### FIELD

The present disclosure relates generally to product packaging and, more particularly, to cartons for packaging product, blanks for forming cartons and methods of forming cartons from blanks. More particularly, though not exclusively, the present disclosure relates to cartons that include an integral handle and that are configured to be stacked.

### BACKGROUND

In the field of packaging and, more particularly, in the field of fresh food packaging, a product is often provided with an exterior container. For example, the product, such as fresh fruit and vegetables, may be packaged in a carton or a bag. Such containers are desirable for shipping and distribution, for product protection, and for display of product identification or promotional information.

It is also desirable that the end consumer be able to use the container as a product carrier when the product is sold. For example, many product containers include a handle that provides the consumer the ability to carry the product. Usually, the handle is located at the top of the container and extends outwardly from the top of the container.

It is also desirable for product containers to be stackable for shipping (e.g., on a pallet), storage (e.g., in a warehouse) or display (e.g., on a store shelf). However, typical containers may make it difficult or impossible to stack the containers due to the lack of structural integrity of the container (e.g., a bag) or due to the configuration of the handle of the container (e.g., a carton).

Additionally, for shipping, product protection and consumer carrying considerations, it is also desirable to ensure that such containers have suitable strength for holding and transporting the product. For cost and environmental considerations, it is also desirable for such containers be formed from as little material as possible and cause as little wastage in the materials as possible. For cost and process considerations, it is also desirable for such containers to be formed through as simple a set of operations as possible to aid in automation of the container formation and loading process.

Accordingly, those skilled in the art continue with research and development efforts in the field of product packaging.

### SUMMARY

Disclosed are cartons for packaging product, blanks for forming the disclosed cartons, methods of forming the disclosed cartons from the disclosed blanks and methods of packaging product using the disclosed cartons. The following is a non-exhaustive list of examples, which may or may not be claimed, of the subject matter according to the present disclosure.

In an example, the disclosed carton includes a bottom wall, a plurality of side walls connected to the bottom wall, a top wall connected to the side walls, and a handle connected to the top wall and movable relative to the top wall between a retracted configuration and a deployed configuration. At least a portion of the top wall forms a planar surface. In the retracted configuration, the handle is in a coplanar relationship with the planar surface. In the deployed configuration, the handle is in a non-coplanar relationship with the planar surface.

In an example, the disclosed blank includes a plurality of side-wall panels connected along a plurality of side-wall fold lines. The blank also includes a plurality of top-wall panels connected to the side-wall panels along a plurality of top-wall fold lines. The blank further includes a plurality of bottom-wall panels connected to the side-wall panels along a plurality of bottom-wall fold lines. The blank additionally includes a first handle connected to a first top-wall panel of the top-wall panels along a first-handle first fold line and a first-handle second fold line. The blank also includes a second handle connected to a second top-wall panel of the top-wall panels along a second-handle first fold line and a second-handle second fold line. The first handle is hingedly movable about the first-handle first fold line and the first-handle second fold line relative to the first top-wall panel. The second handle is hingedly movable about the second-handle first fold line and the second-handle second fold line relative to the second top-wall panel.

In an example, the disclosed method includes a step of manipulating a blank such that a plurality of panels forms a bottom wall, a plurality of side walls, and a top wall of the carton 100. At least a portion of the top wall forms a planar surface. A handle of the carton is connected to the top wall and is movable relative to the top wall between a retracted configuration and a deployed configuration. In the retracted configuration, the handle is in a coplanar relationship with the planar surface. In the deployed configuration, the handle is in a non-coplanar relationship with the planar surface.

In an example, the disclosed method includes steps of: (1) partially erecting a carton to form a bottom wall and a plurality of side walls; (2) loading product into an internal volume of the carton; and (3) further erecting the carton to form a top wall. At least a portion of the top wall forms a planar surface. A handle of the carton is connected to the top wall and is in a coplanar relationship with the planar surface.

Other examples of the disclosed cartons, blanks and methods will become apparent from the following detailed description, the accompanying drawings, and the appended claims.

### BRIEF DESCRIPTION OF THE DRAWINGS

FIG. 1 is a schematic, plan view of an example of a blank used to form a carton;

FIG. 2 is a schematic, perspective view of an example of a carton for packaging product;

FIG. 3 is a schematic, perspective view of the example of the carton;

FIG. 4 is a schematic, perspective view of the example of the carton;

FIG. 5 is a schematic, perspective view of an example of a plurality of the cartons shown in a stacked arrangement;

FIG. 6 is a schematic, perspective view of an example of the carton in an open configuration;

FIG. 7 is a schematic, perspective view of an example of the carton in a closed configuration; and

FIG. 8 is a schematic, sectional view of a portion of the carton.

### DETAILED DESCRIPTION

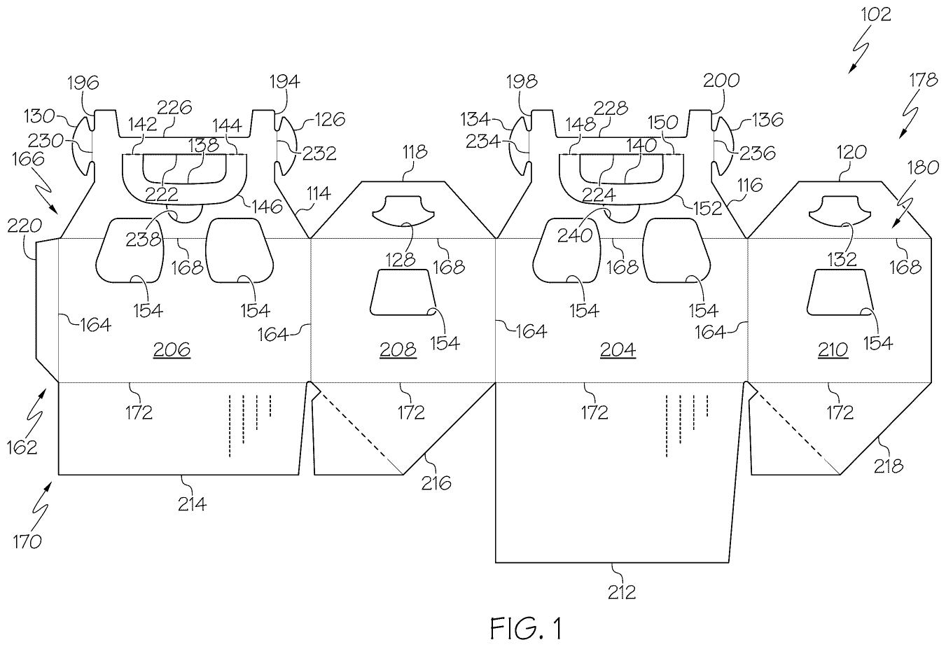

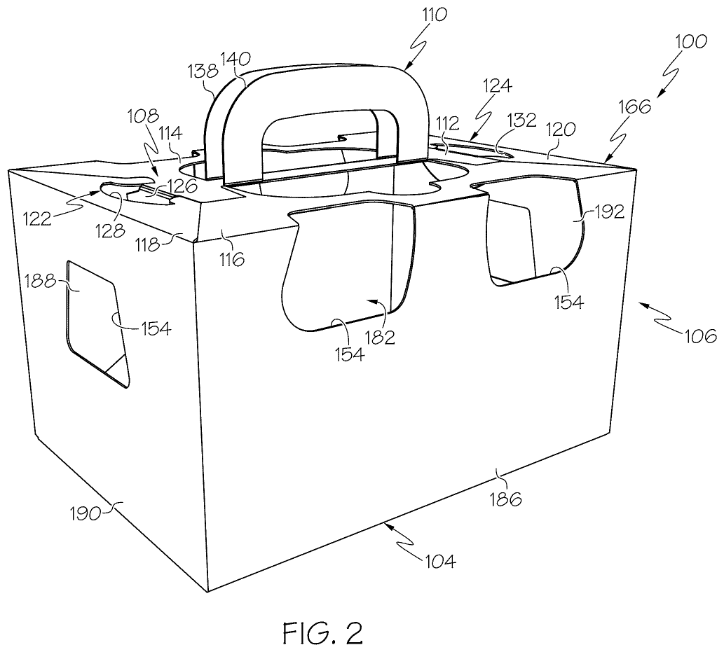

Referring to FIGS. 1-8, by way of examples, the present disclosure is directed to a carton 100 for packaging product (e.g., as shown in FIGS. 2-8) and a blank 102 for forming the carton 100 (e.g., as shown in FIG. 1). The carton 100 facilitates packaging, shipping and displaying of the product. In other words, the carton 100 provides, or serves as, an exterior packaging container for the product.

In one or more examples, the carton 100 also beneficially provides, or serves, as a carrier for the product, for example, after purchase by the consumer. For example, the carton 100 includes a handle 110. The handle 110 is deployable and enables the consumer to easily grip and carry the carton 100, filled with product.

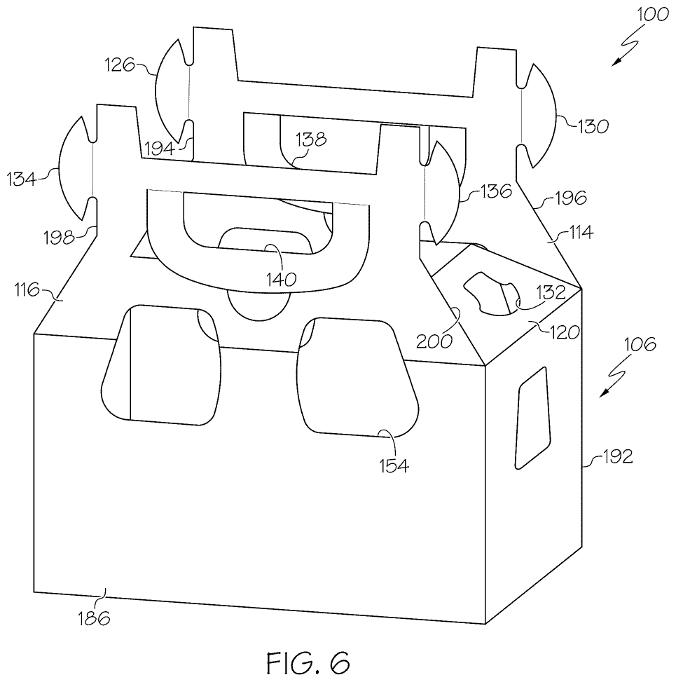

In one or more examples, the carton 100 also beneficial provides, or serves as, a support structure for stacking a plurality of cartons (e.g., a second carton 184 on top of the carton 100 as shown in FIG. 6). For example, the carton 100 includes a planar surface 112 formed by a top or upper portion of the carton 100. the planar surface 112 is configured to serve as a support surface for another carton 100 (e.g., the second carton 184) to be stacked. The handle 110 is retractable and enables the planar surface 112 to be unobstructed by the handle 110.

The carton 100 may be made from any suitable stock material or other packaging material. Examples of suitable stock material include paperboard, corrugated board, cardboard, plastic, combinations thereof and any other suitable material known to those skilled in the art and guided by the teachings provided herein.

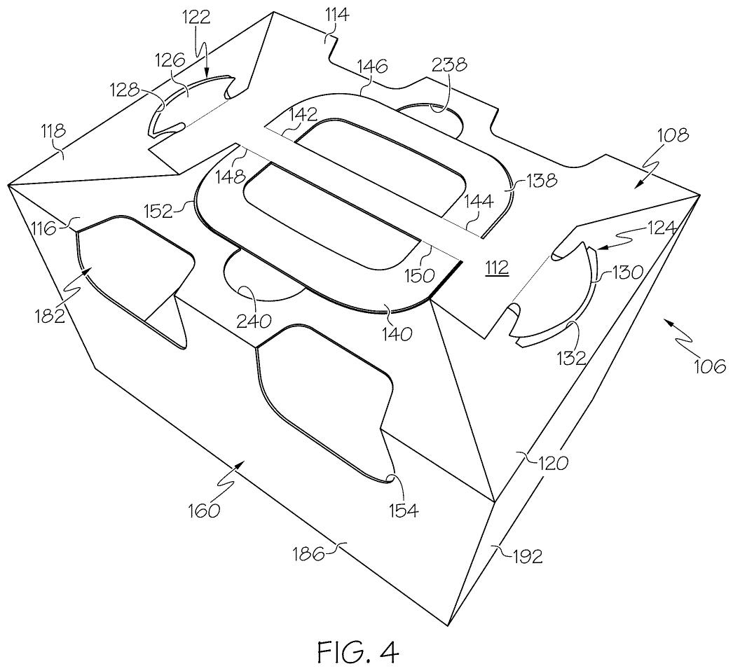

The product may be any one of various types of primary product packaged by the carton 100. In one or more examples, the product is fresh food, such as fresh fruit or fresh vegetables (e.g., grapes as shown in FIG. 4). The carton 100 may be suitably sized and shaped to accommodate any reasonable number of products. Thus, throughout the present disclosure, the term “product” refers to one or more products.

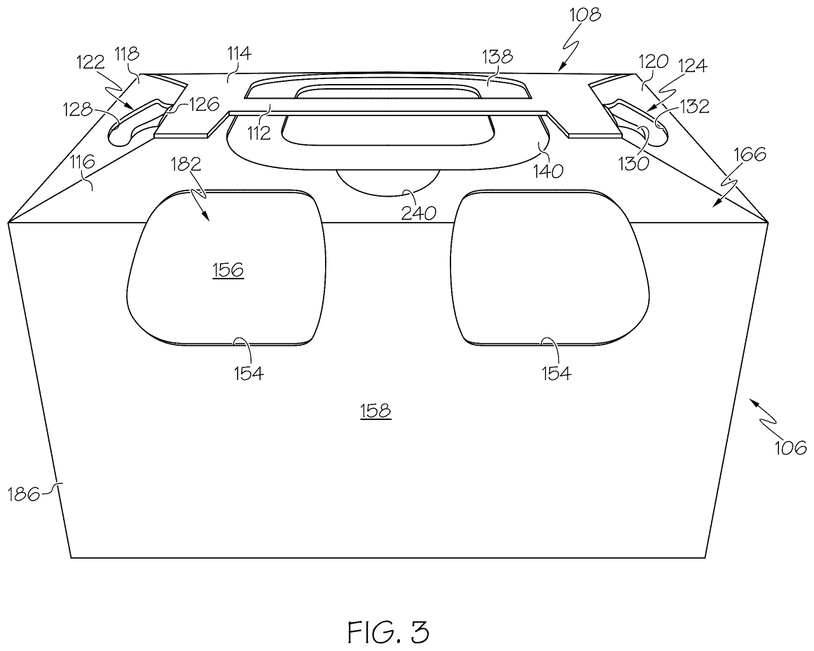

Referring now to FIGS. 2-4, in one or more examples, the carton 100 includes a bottom wall 104, a plurality of side walls 106, a top wall 108, and the handle 110. The side walls 106 are connected to the bottom wall 104. The top wall 108 is connected to the side walls 106. The handle 110 is connected to the top wall 108 and is movable relative to the top wall 108 between a retracted configuration (e.g., as shown in FIGS. 3 and 4) and a deployed configuration (e.g., as shown in FIG. 2). At least a portion of the top wall 108 forms the planar surface 112. In the retracted configuration, the handle 110 is in a coplanar relationship with the planar surface 112. In the deployed configuration, the handle 110 is in a non-coplanar relationship with the planar surface 112.

For the purpose of the present disclosure, the term “retracted,” “retractable,” and like terms or variations thereof, for example, when referring to the handle 110, refer to a configuration, condition or position of the handle 110 in which the handle 110 is positioned, folded, or otherwise drawn back into a stowed or non-use position. For example, with the handle 110 in the retracted configuration, the handle 110 is in an at least approximately horizontal orientation relative to the top wall 108 of the carton 100 such that the handle 110 is in the coplanar relationship with or forms a portion of the planar surface 112 of the carton 100.

For the purpose of the present disclosure, the terms “deployed,” “deployable,” and like terms or variations thereof, for example, when referring to the handle 110, refer to a configuration, condition or position of the handle 110 in which the handle 110 is positioned, folded, or otherwise extended into a ready-for-use position. For example, with the handle 110 in the deployed configuration, the handle 110 is in an at least approximately vertical orientation or extends orthogonally relative to the top wall 108 of the carton 100 such that the handle 110 is in the non-coplanar relationship with the planar surface 112 of the carton 100.

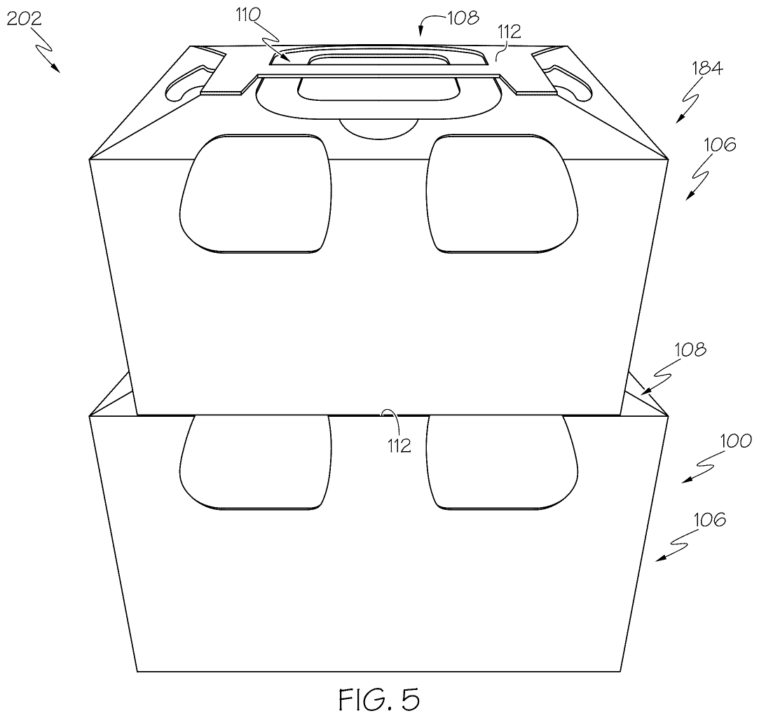

In one or more examples, the handle 110 is initially provided in the retracted configuration, for example, when the carton 100 is formed from the blank 102 (e.g., as shown in FIG. 1) or while product is being loaded into the internal volume 182 of the carton 100. The handle 110 remains or is positioned in the retracted configuration during shipping and/or when displayed such that two or more of the cartons 100 may be stacked one on top of the other (e.g., as shown in FIG. 5). The handle 110 is moved to the deployed configuration (e.g., as shown in FIG. 2), for example, to grip, handle, or otherwise carry the carton 100. The handle 110 may easily be moved between the retracted configuration and the deployed configuration as needed.

For the purpose of the present disclosure, the term “coplanar” and variations thereof refer to a condition in which at least portions of two or more items are or operate in at least approximately the same virtual plane. For example, the term “coplanar” includes two items being approximately coplanar, substantially coplanar, and exactly coplanar.

For the purpose of the present disclosure, the term “non-coplanar” and variations thereof refer to a condition in which at least portions of two or more items are or operate in different virtual planes. For example, the term “non-coplanar” includes two items being oblique to each other or perpendicular to each other.

Generally, the bottom wall 104, the side walls 106, and the top wall 108 form an internal volume 182 of the carton 100. The bottom wall 104, the side walls 106, and the top wall 108 enclose the product for shipping, display, and/or sale.

In the examples illustrated in FIGS. 2-7, the carton 100 includes four side walls 106 and has a generally cuboid shape in three-dimensions (e.g., a square or rectangular shape in cross section). For example, as best shown in FIG. 2, the carton 100 includes a first side wall 186 (e.g., a front wall), a second side wall 188 (e.g., a rear wall), spaced away from and opposite the first side wall 186, a third side wall 190 (e.g., a left-end wall), connected to and extending between the first side wall 186 and the second side wall 188, and a fourth side wall 192 (e.g., a right-end wall), connected to and extending between the first side wall 186 and the second side wall 188 opposite the third side wall 190.

In other examples (not explicitly shown), the carton 100 includes any suitable number of side walls 106 and/or may have any other suitable three-dimensional shape or cross-sectional shape. For example, the carton 100 may include less than four or more than four side walls.

In one or more examples, each one of the side walls 106 is connected to the bottom wall 104. The top wall 108 is spaced away from and is opposite the bottom wall 104. In one or more examples, the top wall 108 is at least approximately parallel to the bottom wall 104.

In one or more examples, the carton 100 includes a plurality of top-wall panels 166 that form the top wall 108. In one or more examples, at least one of the top-wall panels 166 is connected to one of the side walls 106. In one or more examples, each one of the top-wall panels 166 is connected to a respective one of the side walls 106. In one or more examples, the carton 100 includes at least two top-wall panels 166 that form the top wall 108. In one or more examples, the carton 100 includes four top-wall panels 166 that form the top wall 108. In still other examples, the carton 100 includes any suitable number of top-wall panels 166 that form the top wall 108.

The handle 110 facilitates carrying the carton 100. In one or more examples, the handle 110 is integral to the top wall 108. For example, the handle 110 is integral to at least one of the top-wall panels 166. As an example, the handle 110 is formed by at least a portion of the top wall 108 (e.g., by at least a portion of one of the top-wall panels 166). As another example, at least a portion of the top wall 108 is formed by the handle 110 (e.g., when the handle 110 is in the retracted configuration).

Referring now to FIGS. 2-4, 6 and 7, in one or more examples, the top wall 108 includes a first top-wall panel 114 and a second top-wall panel 116. The first top-wall panel 114 and the second top-wall panel 116 are movable relative to respective ones of the side walls 106 between an open configuration (e.g., as shown in FIG. 6) and a closed configuration (e.g., as shown in FIGS. 2-4 and 7). In other words, in the closed configuration, the first top-wall panel 114 and the second top-wall panel 116, in combination, form at least a portion of the top wall 108 (e.g., a composite top wall).

For the purpose of the present disclosure, the phrase “closed configuration,” with reference to the top-wall panels that form the top wall 108 of the carton 100, refers to a configuration, condition, or position of the top-wall panels in which the top-wall panels are in an at least approximately horizontal orientation to form the top wall 108, which encloses the internal volume 182 of the carton 100. For the purpose of the present disclosure, the phrase “open configuration,” with reference to the top-wall panels that form the top wall 108 of the carton 100, refers to a configuration, condition, or position of the top-wall panels in which the top-wall panels are in an at least approximately vertical orientation to provide an opening through which to access the internal volume 182 of the carton 100.

In one or more examples, in the closed configuration, at least a portion of the first top-wall panel 114 overlaps at least a portion of the second top-wall panel 116. For example, at least a portion of the first top-wall panel 114 is in a face-to-face relationship and is aligned with at least a portion of the second top-wall panel 116.

In one or more examples, the second top-wall panel 116 is opposite the first top-wall panel 114. For example, the first top-wall panel 114 is connected to and is hingedly movable (e.g., foldable) relative to the second side wall 188. The second top-wall panel 116 is connected to and is hingedly movable (e.g., foldable) relative to the first side wall 186. However, in other examples, this arrangement may be reversed, for example, the first top-wall panel 114 is connected to the first side wall 186 and the second top-wall panel 116 is connected to the second side wall 188.

In one or more examples, in the closed configuration, at least a portion of the first top-wall panel 114 and at least a portion of the second top-wall panel 116 form the planar surface 112. For example, in the closed configuration, at least a portion of the first top-wall panel 114 and at least a portion of the second top-wall panel 116 are in an at least approximately horizontal orientation and are at least approximately parallel to each other.

In one or more examples, at least a portion of the planar surface 112 is formed by the handle 110 and the top wall 108. For example, with the top wall 108 in the closed configuration and the handle 110 in the retracted configuration, the handle 110 and the top wall 108 are at least approximately coplanar and at least approximately parallel to the bottom wall 104.

Referring still to FIGS. 2-4, 6 and 7, in one or more examples, the top wall 108 includes a third top-wall panel 118 and a fourth top-wall panel 120. The third top-wall panel 118 and the fourth top-wall panel 120 are movable relative to respective ones of the side walls 106 between the open configuration and the closed configuration. In other words, in the closed configuration, the first top-wall panel 114, the second top-wall panel 116, the third top-wall panel 118, and the fourth top-wall panel 120, in combination, form at least a portion of the top wall 108 (e.g., a composite top wall).

In one or more examples, in the closed configuration, a portion of the first top-wall panel 114 and a portion of the second top-wall panel 116 overlap a portion of the third top-wall panel 118. In the closed configuration, a portion of the first top-wall panel 114 and a portion of the second top-wall panel 116 overlap a portion of the fourth top-wall panel 120.

In one or more examples, the fourth top-wall panel 120 is opposite the third top-wall panel 118. For example, the third top-wall panel 118 is connected to and is hingedly movable (e.g., foldable) relative to the third side wall 190. The fourth top-wall panel 120 is connected to and is hingedly movable (e.g., foldable) relative to the fourth side wall 192.

In one or more examples, the at least a portion of the first top-wall panel 114, at least a portion of the second top-wall panel 116, at least a portion of the third top-wall panel 118, and at least a portion of the fourth top-wall panel 120 form the planar surface 112. For example, in the closed configuration, at least a portion of the first top-wall panel 114, at least a portion of the second top-wall panel 116, at least a portion of the third top-wall panel 118, and at least a portion of the fourth top-wall panel 120 are in an at least approximately horizontal orientation and are at least approximately parallel to each other.

In one or more examples, the planar surface 112 is approximately planar or substantially planar but may not be exactly planar. As an example, as used herein, the term “planar surface” may include conditions in which one portion of the planar surface is at least approximately parallel to but is slightly offset or spaced away another portion of the planar surface to accommodate or account for a thickness of the stock material forming the top-wall panels of the top wall 108, for example, due to the overlapping configuration of portions of the first top-wall panel 114, the second top-wall panel 116, the third top-wall panel 118, and/or the fourth top-wall panel 120.

Referring now to FIGS. 2-4 and 6-8, in one or more examples, the top-wall panels 166 (e.g., first top-wall panel 114, second top-wall panel 116, third top-wall panel 118, and fourth top-wall panel 120) are releasably coupled together to form the top wall 108 in the closed configuration. Releasably coupling the top-wall panels 166 enables the top wall 108 to be positioned between the open configuration and the closed configuration and secured in the closed configuration. With the top-wall panels 166 coupled together, the top wall 108 is configured to hold the carton 100 in a constructed (e.g., erected) configuration and to keep the carton 100 closed around the product.

In one or more examples, the first top-wall panel 114 is releasably coupled to the third top-wall panel 118 and to the fourth top-wall panel 120. In one or more examples, the second top-wall panel 116 is releasably coupled to the third top-wall panel 118 and to the fourth top-wall panel 120. In one or more examples, the first top-wall panel 114 and the second top-wall panel 116 are releasably coupled to the third top-wall panel 118 and to the fourth top-wall panel 120.

Referring to FIGS. 2-4 and 6-8, in one or more examples, the carton 100 includes at least one locking feature that is configured to releasable couple the top-wall panels 166 in the closed configuration to form the top wall 108. The locking features may take any suitable form or include any suitable structure or configuration, depending, for example, of the size, shape, and/or geometry of the carton 100.

In one or more examples, the carton 100 includes a first locking feature 122. The first locking feature 122 is configured to couple the first top-wall panel 114 and the second top-wall panel 116 to the third top-wall panel 118 in the closed configuration. The carton 100 also includes a second locking feature 124. The second locking feature 124 is opposite the first locking feature 122. The second locking feature 124 is configured to couple the first top-wall panel 114 and the second top-wall panel 116 to the fourth top-wall panel 120 in the closed configuration.

The first locking feature 122 and the second locking feature 124 may include any suitable mechanical locking mechanism known to those skilled in the art and guided by the teachings provided herein. In one or more examples, each one of the first locking feature 122 and the second locking feature 124 includes a male portion forming a first part the complimentary locking mechanism and a female portion forming a second part of the complimentary locking mechanism.

Referring now to FIGS. 2-4 and 6-8, in one or more examples, the first locking feature 122 includes a first locking tab 126 (e.g., male portion) and a first locking aperture 128 (e.g., female portion). The first locking tab 126 is connected to the first top-wall panel 114. For example, the first locking tab 126 extends outwardly from a first-top-wall-panel first edge 194 of the first top-wall panel 114. The first locking aperture 128 is formed in (e.g., through) the third top-wall panel 118.

In one or more examples, the second locking feature 124 includes a second locking tab 130 (e.g., male portion) and a second locking aperture 132 (e.g., female portion). The second locking tab 130 is connected to the first top-wall panel 114 opposite the first locking tab 126. For example, the second locking tab 130 extends outwardly from a first-top-wall-panel second edge 196 of the first top-wall panel 114. The second locking aperture 132 is formed in (e.g., through) the fourth top-wall panel 120.

In one or more examples, at least a portion of the first locking tab 126 is configured to be received by and to be secured in the first locking aperture 128 to secure (e.g., lock) a first end of the first top-wall panel 114 to the third top-wall panel 118 in the closed configuration. At least a portion of the second locking tab 130 is configured to be received by and to be secured in the second locking aperture 132 to secure (e.g., lock) a second end of the first top-wall panel 114 to the fourth top-wall panel 120 in the closed configuration.

In one or more examples, the first locking feature 122 includes a third locking tab 134. The third locking tab 134 is connected to the second top-wall panel 116. For example, the third locking tab 134 extends outwardly from a second-top-wall-panel first edge 198 of the second top-wall panel 116. The second locking feature 124 includes a fourth locking tab 136. The fourth locking tab 136 is connected to the second top-wall panel 116 opposite the third locking tab 134. For example, the fourth locking tab 136 extends outwardly from a second-top-wall-panel second edge 200 of the second top-wall panel 116.

In one or more examples, in the closed configuration, at least a portion of the first locking tab 126 overlaps at least a portion of the third locking tab 134. In the closed configuration, at least a portion of the second locking tab 130 overlaps at least a portion of the fourth locking tab 136. At least a portion of the third locking tab 134 is configured to be received by and to be secured in the first locking aperture 128 to secure (e.g., lock) a first end of the second top-wall panel 116 to the third top-wall panel 118 in the closed configuration. At least a portion of the fourth locking tab 136 is configured to be received by and to be secured in the second locking aperture 132 to secure (e.g., lock) a second end of the second top-wall panel 116 to the fourth top-wall panel 120 in the closed configuration.

In one or more examples, at least a portion of the top wall 108 includes a double-walled or two-layers construction formed by overlapping portions of two of more of the top-wall panels 166. The top wall 108 having a double-layered construction, formed by the overlapping portions of at least two of the top-wall panels 166, provides additional reinforcement and structural integrity to the carton 100, for example, for stacking purposes.

Referring again to FIGS. 2-4, in one or more examples, the handle 110 includes a first handle 138 and a second handle 140. The first handle 138 is connected to and is hingedly movable (e.g., foldable) relative to the first top-wall panel 114 between the retracted configuration and the deployed configuration. The second handle 140 is connected to and is hingedly movable (e.g., foldable) relative to the second top-wall panel 116 between the retracted configuration and the deployed configuration.

In one or more examples, in the retracted configuration, the first handle 138 is in a coplanar relationship with the first top-wall panel 114 and the second handle 140 is in a coplanar relationship with the second top-wall panel 116. For example, with the first handle 138 and the second handle 140 in the retracted configuration and with the first top-wall panel 114 and the second top-wall panel 116 in the closed configuration, the first handle 138 and the second handle 140 form a portion of or are in an at least approximately coplanar relationship with the planar surface 112 of the carton 100.

In one or more examples, in the deployed configuration, the first handle 138 is in a non-coplanar relationship with the first top-wall panel 114 and the second handle 140 is in a non-coplanar relationship with the second top-wall panel 116. For example, with the first top-wall panel 114 and the second top-wall panel 116 in the closed configuration and with the first handle 138 and the second handle 140 in the deployed configuration and, the first handle 138 and the second handle 140 extend upwardly from or are in a non-coplanar relationship with (e.g., oblique or perpendicular to) the planar surface 112 of the carton 100.

It can be appreciated that, as used herein, the handle 110 (e.g., the first handle 138 and the second handle 140) being coplanar with the planar surface 112 or a portion of the top wall 108 (e.g., a respective one of the first top-wall panel 114 or the second top-wall panel 116) may include conditions in which the handle 110 or a portion of the handle 110 (e.g., the first handle 138 and the second handle 140) is at least approximately parallel to the planar surface 112 or a portion of the top wall 108 but is slightly offset or spaced away from the planar surface 112 or a portion of the top wall 108 to accommodate or account for a thickness of the stock material forming the first top-wall panel 114 and the second top-wall panel 116 due to the overlapping configuration of portions of the first top-wall panel 114 and the second top-wall panel 116.

In one or more examples, the first handle 138 is integral to the first top-wall panel 114. As an example, the first handle 138 is formed by at least a portion of the first top-wall panel 114. As another example, at least a portion of the first top-wall panel 114 is formed by the first handle 138. With the first handle 138 in the retracted position, the first handle 138 forms a portion of the top wall 108, such as a portion of the planar surface 112.

In one or more examples, the second handle 140 is integral to the second top-wall panel 116. As an example, the second handle 140 is formed by at least a portion of the second top-wall panel 116. As another example, at least a portion of the second top-wall panel 116 is formed by the second handle 140. With the second handle 140 in the retracted position, the second handle 140 forms a portion of the top wall 108, such as a portion of the planar surface 112.

Referring now to FIG. 4, in one or more examples, the first handle 138 is connected to the first top-wall panel 114 along a first-handle first fold line 142, a first-handle second fold line 144, and a first-handle perforated line 146. The second handle 140 is connected to the second top-wall panel 116 along a second-handle first fold line 148, a second-handle second fold line 150, and a second-handle perforated line 152. The first handle 138 is separable from the first top-wall panel 114 along the first-handle perforated line 146 to move the first handle 138 from the retracted configuration to the deployed configuration. The second handle 140 is separable from the second top-wall panel 116 along the second-handle perforated line 152 to move the second handle 140 from the retracted configuration to the deployed configuration.

In one or more examples, the first handle 138 is initially connected to the first top-wall panel 114 along the first-handle perforated line 146 and the second handle 140 is initially connected to the second top-wall panel 116 along the second-handle perforated line 152, for example, when the carton 100 is formed from the blank 102 (e.g., as shown in FIG. 1) and after product is loaded into the internal volume 182 of the carton 100 and the top-wall panels are positioned in the closed configuration. In these examples, the physical connection of the first handle 138 to the first top-wall panel 114 along the first-handle perforated line 146 and the second handle 140 to the second top-wall panel 116 along the second-handle perforated line 152 provides increased structural strength and load bearing capacity to the planar surface 112 formed by the top wall 108, the first handle 138, and the second handle 140 for stacking of multiple cartons 100 (e.g., as shown in FIG. 5). The first-handle perforated line 146 and the second-handle perforated line 152 facilitate easy separation of the first handle 138 and the second handle 140 for positioning in the deployed configuration.

Referring FIGS. 2-7, in one or more examples, the carton 100 includes at least one opening 154. In one or more examples, the at least one opening 154 is formed in (e.g., through) at least one of the side walls 106. In one or more examples, the at least one opening 154 is formed in (e.g., through) at least one of the top-wall panels (e.g., the first top-wall panel 114 and/or the second top-wall panel 116). In one or more examples, a first portion of the opening 154 is formed in one of the side walls 106 (e.g., the first side wall 186) and second portion of the opening 154 is formed in one of the top-wall panels (e.g., the second top-wall panel 116).

The at least one opening 154 may have any suitable size, shape, and/or dimension. The at least one opening 154 provides for a flow of fresh air into the internal volume 182 of the carton 100 and through the carton 100, for example, to preserve the freshness of the product housed within the carton 100. The at least one opening 154 also provides a retailer or consumer suitable visual access to the product housed within the carton 100.

In one or more examples, the carton 100 is erected from the blank 102 (e.g., as shown in FIG. 1) of a stock material. In one or more examples, the stock material includes paperboard. In one or more examples, the stock material includes cardboard.

Referring now to FIG. 3, the carton 100 includes an interior surface 156 and an exterior surface 158. In one or more examples, at least a portion of the interior surface 156 includes a surface coating. In one or more examples, at least a portion of the exterior surface 158 includes a surface coating. The surface coating may provide any desired functionality, such as, but not limited to, durability, tear-resistance, liquid resistance, glue-ability, heat sealability, printability, food contact, and the like. The surface coating may be applied by any suitable technique.

Referring now to FIG. 4, in one or more examples, at least a portion of the exterior surface 158 includes indicia 160. For example, the indicia 160 may include, but is not limited to, product information, branding, or other design characteristics.

Referring now to FIG. 1, which illustrates an example of the blank 102 used to form (e.g., make, erect, or otherwise construct) the carton 100. The blank 102 generally refers to a blank sheet of material, such as a suitable substrate material, that is cut or otherwise formed into a desired size, shape, and configuration for erection of the carton 100.

In one or more examples, the blank 102 includes a plurality of panels 178 connected along a plurality of fold lines 180. For example, the panels 178 may be arranged in series and connected one to the next by a respective one of the fold lines 180.

For clarity, it should be recognized that a first surface of the blank 102 is exposed (e.g., projecting towards the viewer) and is shown in FIG. 1. For example, the first surface of the blank 102 may become the interior surface 156 of the carton 100. The blank 102 also includes a corresponding second surface (e.g., underside) that is not seen until the carton 100 is formed from the blank 102. For example, the second surface of the blank 102 may become the exterior surface 158 of the carton 100.

In one or more examples, the blank 102 includes a plurality of side-wall panels 162. The side-wall panels 162 are connected along a plurality of side-wall fold lines 164. The blank 102 includes a plurality of top-wall panels 166. The top-wall panels 166 are connected to the side-wall panels 162 along a plurality of top-wall fold lines 168. The blank 102 includes a plurality of bottom-wall panels 170. The bottom-wall panels 170 are connected to the side-wall panels 162 along a plurality of bottom-wall fold lines 172. The blank 102 includes the first handle 138. The first handle 138 is connected to the first top-wall panel 114 of the top-wall panels 166 along the first-handle first fold line 142 and the first-handle second fold line 144. The blank 102 includes the second handle 140. The second handle 140 is connected to the second top-wall panel 116 of the top-wall panels 166 along the second-handle first fold line 148 and the second-handle second fold line 150.

In one or more examples, the first handle 138 is hingedly movable about the first-handle first fold line 142 and the first-handle second fold line 144 relative to the first top-wall panel 114. The second handle 140 is hingedly movable about the second-handle first fold line 148 and the second-handle second fold line 150 relative to the second top-wall panel 116.

In one or more examples, when the carton 100 is formed from the blank 102 (e.g., as shown in FIGS. 2-4 and 6-8), the bottom-wall panels 170 form the bottom wall 104 of the carton 100, the side-wall panels 162 form the plurality of side walls 106 of the carton 100, and the top-wall panels 166 form the top wall 108 of the carton 100. When the carton 100 is formed from the blank 102, at least a portion of the top wall 108 forms the planar surface 112. When the carton 100 is formed from the blank 102, the first handle 138 and the second handle 140 are in a coplanar relationship with the planar surface 112. Expressed another way, when the carton 100 is formed from the blank 102, the first handle 138 and the second handle 140 extend from and are in an at least approximately coplanar relationship with the first top-wall panel 114 and the second top-wall panel 116, respectively, and form a portion of the planar surface 112.

In one or more examples, when the carton 100 is formed from the blank 102, the first handle 138 and the second handle 140 are hingedly movable to a non-coplanar relationship with the planar surface 112. Expressed another way, when the carton 100 is formed from the blank 102, the first handle 138 and the second handle 140 are deployable from the top wall 108 to extend from and to be positioned in a non-coplanar relationship with the first top-wall panel 114 and the second top-wall panel 116, respectively, and form the handle 110.

In one or more examples, the first handle 138 is connected to the first top-wall panel 114 along the first-handle perforated line 146. The second handle 140 is connected to the second top-wall panel 116 along the second-handle perforated line 152. The first handle 138 is separable from the first top-wall panel 114 along the first-handle perforated line 146. The second handle 140 is separable from the second top-wall panel 116 along the second-handle perforated line 152.

In one or more examples, when the carton 100 is formed from the blank 102, the top-wall panels 166 are hingedly movable relative to respective ones of the side-wall panels 162 between the open configuration and the closed configuration.

In one or more examples, when the carton 100 is formed from the blank 102, a portion of the first top-wall panel 114 overlaps a portion of the second top-wall panel 116. At least a portion of the first top-wall panel 114 and at least a portion of the second top-wall panel 116 form the planar surface 112 of the carton 100.

In one or more examples, the blank 102 includes a first cutout 222, or other opening, formed in (e.g., through) the first top-wall panel 114. The first cutout 222 may be located along, or interrupt, the first-handle first fold line 142 and the first-handle second fold line 144. The first cutout 222 provides or forms a contoured edge of the first handle 138 and a portion of a first edge of a first strap 226 of the first top-wall panel 114. For example, the first strap 226 extends between the first locking tab 126 and the second locking tab 130 and forms a central portion of the top wall 108 when the carton 100 is formed from the blank 102 and the top-wall panels 166 are in the closed configuration.

In one or more examples, the blank 102 includes a second cutout 224, or other opening, formed in (e.g., through) the second top-wall panel 116. The second cutout 224 may be located along, or interrupt, the second-handle first fold line 148 and the second-handle second fold line 150. The second cutout 224 provides or forms a contoured edge of the second handle 140 and a portion of a first edge of a second strap 228 of the second top-wall panel 116. For example, the second strap 228 extends between the third locking tab 134 and the fourth locking tab 136 and forms a central portion of the top wall 108 when the carton 100 is formed from the blank 102 and the top-wall panels 166 are in the closed configuration. In one or more examples, when the carton 100 is formed from the blank 102 and the top-wall panels 166 are in the closed configuration, at least a portion of the first strap 226 overlaps at least a portion of the second strap 228.

In one or more examples, the blank 102 includes the first locking feature 122 and the second locking feature 124 that are configured to releasably couple the top-wall panels 166 together in the closed configuration.

In one or more examples, the blank 102 includes the first locking tab 126 (e.g., male portion) of the first locking feature 122. The first locking tab 126 extends from and is hingedly (e.g., foldably) connected to the first top-wall panel 114 along a first-locking-tab fold line 230.

In one or more examples, the blank 102 includes the first locking aperture 128 (e.g., female portion) of the first locking feature 122. The first locking aperture 128 is formed in (e.g., through) the third top-wall panel 118.

When the carton 100 is formed from the blank 102 and the top-wall panels 166 are positioned in the closed configuration, the first locking tab 126 is aligned with (e.g., over) the first locking aperture 128 and is foldable (e.g., downwardly) about the first-locking-tab fold line 230 from an approximately coplanar orientation relative to the first top-wall panel 114 (e.g., as shown in FIGS. 1 and 4) to a non-coplanar orientation (e.g., oblique or approximately perpendicular) relative to the first top-wall panel 114 (e.g., as shown in FIGS. 2, 3, 7 and 8) to be received and secured within the first locking aperture 128.

In one or more examples, the blank 102 includes the second locking tab 130 (e.g., male portion) of the second locking feature 124. The second locking tab 130 extends from and is hingedly (e.g., foldably) connected to the first top-wall panel 114 along a second-locking-tab fold line 232, opposite the first locking tab 126.

In one or more examples, the blank 102 includes the second locking aperture 132 (e.g., female portion) of the second locking feature 124. The second locking aperture 132 is formed in (e.g., through) the fourth top-wall panel 120.

When the carton 100 is formed from the blank 102 and the top-wall panels 166 are positioned in the closed configuration, the second locking tab 130 is aligned with (e.g., over) the second locking aperture 132 and is foldable (e.g., downwardly) about the second-locking-tab fold line 232 from an approximately coplanar orientation relative to the first top-wall panel 114 (e.g., as shown in FIGS. 1 and 4) to a non-coplanar orientation (e.g., oblique or approximately perpendicular) relative to the first top-wall panel 114 (e.g., as shown in FIGS. 2, 3 and 7) to be received and secured within the second locking aperture 132.

In one or more examples, when the carton 100 is formed from the blank 102, the first locking tab 126, the first locking aperture 128, the second locking tab 130, and the second locking aperture 132 cooperate to couple the first top-wall panel 114 to the third top-wall panel 118 and to the fourth top-wall panel 120.

In one or more examples, the blank 102 includes the third locking tab 134 (e.g., male portion) of the first locking feature 122. The third locking tab 134 extends from and is hingedly (e.g., foldably) connected to the second top-wall panel 116 along a third-locking-tab fold line 234.

When the carton 100 is formed from the blank 102 and the top-wall panels 166 are positioned in the closed configuration, the third locking tab 134 is aligned with (e.g., over) the first locking aperture 128 and is foldable (e.g., downwardly) about the third-locking-tab fold line 234 from an approximately coplanar orientation relative to the second top-wall panel 116 (e.g., as shown in FIGS. 1 and 4) to a non-coplanar orientation (e.g., oblique or approximately perpendicular) relative to the second top-wall panel 116 (e.g., as shown in FIGS. 2, 3, 7 and 8) to be received and secured within the first locking aperture 128.

In one or more examples, the blank 102 includes the fourth locking tab 136 (e.g., male portion) of the second locking feature 124. The fourth locking tab 136 extends from and is hingedly (e.g., foldably) connected to the second top-wall panel 116 along a fourth-locking-tab fold line 236, opposite the third locking tab 134.

When the carton 100 is formed from the blank 102 and the top-wall panels 166 are positioned in the closed configuration, the fourth locking tab 136 is aligned with (e.g., over) the second locking aperture 132 and is foldable (e.g., downwardly) about the fourth-locking-tab fold line 236 from an approximately coplanar orientation relative to the second top-wall panel 116 (e.g., as shown in FIGS. 1 and 4) to a non-coplanar orientation (e.g., oblique or approximately perpendicular) relative to the second top-wall panel 116 (e.g., as shown in FIGS. 2, 3 and 7) to be received and secured within the second locking aperture 132.

In one or more examples, when the carton 100 is formed from the blank 102, the first locking tab 126, the first locking aperture 128, the second locking tab 130, and the second locking aperture 132 cooperate to couple the first top-wall panel 114 to the third top-wall panel 118 and to the fourth top-wall panel 120.

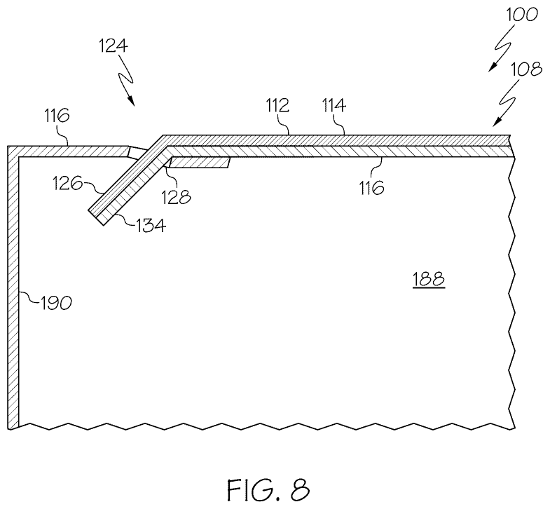

In one or more examples, the third locking tab 134 is aligned with and is situated under the first locking tab 126, as best illustrated in FIG. 8. FIG. 8 illustrates an example of the first locking feature 122, including the first locking tab 126 and the third locking tab 134 received by the first locking aperture 128. An example of the second locking feature 124, including the second locking tab 130 and the fourth locking tab 136 received by the second locking aperture 132, has substantially the same configuration as that shown for the first locking feature 122 in FIG. 8. For example, the fourth locking tab 136 is aligned with and is situated under the second locking tab 130.

The configuration of the top-wall panels 166 and the first and second locking features 122, 124 enables the carton 100 to be positioned in the closed configuration and the first and second locking features 122, 124 to be engaged to lock the top-wall panels 166 in the closed configuration with only one hand (e.g., after being loaded with product). This is a significant advantage over previous product cartons, which typically require two hands to closed and lock the carton. For example, a user may fold the first and second top-wall panels 114, 116 downwardly using only one hand. Downward folding of the first and second top-wall panels 114, 116 properly orients and situates the top-wall panels 166 and the first and second locking features 122, 124 for closure to form and lock the top wall 108 in the closed configuration. For example, the first and second top-wall panels 114, 116 are folded downward until at least a portion of the first top-wall panel 114 overlaps at least a portion of the second top-wall panel 116, the first and third locking tabs 126, 134 are aligned and situated over the first locking aperture 128, and the second and fourth locking tabs 130, 136 are aligned and situated over the second locking aperture 132. During downward folding, the first and second top-wall panels 114, 116 may also contact the third and fourth top-wall panels 118, 120 to urge the third and fourth top-wall panels 118, 120 downwardly to the closed configuration. With the top-wall panels 166 in the closed configuration, the user may fold the first and third locking tabs 126, 134 downward to insert and lock them into the first locking aperture 128 using one finger (e.g., the thumb) of one hand and may simultaneously fold the second and fourth locking tabs 130, 136 downward to insert and lock them into the second locking aperture 132 using another finger (e.g., index finger or ring finger) of same hand.

Generally, the first locking tab 126 and the third locking tab 134 and the first locking aperture 128 have complementary and mating shapes that enable the first locking tab 126 and the third locking tab 134 to be press-fitted in and at least a portion of the first locking tab 126 and the third locking tab 134 to pass through the first locking aperture 128 in one direction but impedes passage (e.g., removal) of the first locking tab 126 and the third locking tab 134 through the first locking aperture 128 in the opposite direction. As an example, the first locking tab 126, the third locking tab 134, and the first locking aperture 128 may have a truncated arrowhead shape.

Similarly, the second locking tab 130 and the fourth locking tab 136 and the second locking aperture 132 have complementary and mating shapes that enable the second locking tab 130 and the fourth locking tab 136 to be press-fitted in and at least a portion of the second locking tab 130 and the fourth locking tab 136 to pass through the second locking aperture 132 in one direction but impedes passage (e.g., removal) of the second locking tab 130 and the fourth locking tab 136 through the second locking aperture 132 in the opposite direction. As an example, the second locking tab 130, the fourth locking tab 136, and the second locking aperture 132 may have a truncated arrowhead shape.

In one or more examples, the locking tabs 126, 130, 134, 136 may include a main portion, connected to and extending from a respective end of a respective one of the first and second top-wall panels 114, 116 and an opposed pair of anchoring portions, connected to and extending outwardly from the main portion. A notch or recess may be formed between each one of the anchoring portions and an end edge of the respective one of the first and second top-wall panels 114, 116. When the locking tabs 126, 130, 134, 136 are received by a respective one of the locking apertures 128, 132, a portion of a respective one of the third top-wall panel 118 and the fourth top-wall panel 120 may be located within the notch, thereby holding the locking tabs 126, 130, 134, 136 within the respective locking apertures 128, 132 by an interference fit.

In one or more examples, the anchoring portions of the locking tabs 126, 130, 134, 136 may be flexed or bent relative to the main portion during insertion within the locking apertures 128, 132. Once the locking tabs 126, 130, 134, 136 have cleared an edge of the locking apertures 128, 132, the anchoring portions may spring back into a more planar condition relative to the main portion (e.g., flatten out due to the natural resilience of the stock material of the blank 102) such that an edge of the anchoring portion abuts an inner surface of a respective one of the third top-wall panel 118 and the fourth top-wall panel 120 when tension is applied in opposition to the locking direction.

In one or more examples, the blank 102 and the carton 100 formed from the blank 102 includes a first notch 238. The first notch 238 is formed in (e.g., through) the first top-wall panel 114. The first notch 238 is located along or interrupts the first-handle perforated line 146. The first notch 238 enables a user to grasp a portion of the first handle 138 (e.g., with a finger) when the first handle 138 is folded down in the retracted configuration.

In one or more examples, the blank 102 and the carton 100 formed from the blank 102 includes a second notch 240. The second notch 240 is formed in (e.g., through) the second top-wall panel 116. The second notch 240 is located along or interrupts the second-handle perforated line 152. The second notch 240 enables a user to grasp a portion of the second handle 140 (e.g., with a finger) when the second handle 140 is folded down in the retracted configuration.

In one or more examples, the blank 102 includes at least one opening 154 formed in at least one of the side-wall panels 162, in at least one of the top-wall panels 166, and/or in at least one of the side-wall panels 162 and at least one of the top-wall panels 166.

The opening 154 may be formed (e.g., cut out) during formation of the blank 102. In one or more examples, the opening 154 may interrupt a fold line, thereby enabling the blank 102 to fold more easily during erection of the carton 100.

In one or more examples, the side-wall panels 162 include a first side-wall panel 204, a second side-wall panel 206, a third side-wall panel 208, and a fourth side-wall panel 210. When the carton 100 is constructed from the blank 102, the first side-wall panel 204 forms the first side wall 186 of the carton 100, the second side-wall panel 206 forms the second side wall 188 of the carton 100, the third side-wall panel 208 forms the third side wall 190 of the carton 100, and the fourth side-wall panel 210 forms the fourth side wall 192 of the carton 100. In other examples, the blank 102 may include more or less than four side-wall panels 162, depending, for example, of the shape of the carton 100 formed by the blank 102.

In one or more examples, the third side-wall panel 208 extends from and is foldably (e.g., hingedly or movable) connected to the first side-wall panel 204 along a respective one of the side-wall fold lines 164. The fourth side-wall panel 210 extends from and is foldably (e.g., hingedly or movable) connected to the first side-wall panel 204, opposite the third side-wall panel 208, along a respective one of the side-wall fold lines 164. The second side-wall panel 206 extends from and is foldably (e.g., hingedly or movable) connected to the third side-wall panel 208, opposite the first side-wall panel 204, along a respective one of the side-wall fold lines 164.

In one or more examples, the top-wall panels 166 include the first top-wall panel 114, the second top-wall panel 116, the third top-wall panel 118, and the fourth top-wall panel 120. When the carton 100 is constructed from the blank 102, the top-wall panels 166 are configured to be positioned in the closed configuration to form the top wall 108 of the carton 100. In other examples, the blank 102 may include more or less than four top-wall panels 166, depending, for example, of the shape of the carton 100 formed by the blank 102.

In one or more examples, the first top-wall panel 114 extends from and is foldably (e.g., hingedly or movable) connected to the second side-wall panel 206 along a respective one of the top-wall fold lines 168. The second top-wall panel 116 extends from and is foldably (e.g., hingedly or movable) connected to the first side-wall panel 204 along a respective one of the top-wall fold lines 168. The third top-wall panel 118 extends from and is foldably (e.g., hingedly or movable) connected to the third side-wall panel 208 along a respective one of the top-wall fold lines 168. The fourth top-wall panel 120 extends from and is foldably (e.g., hingedly or movable) connected to the fourth side-wall panel 210 along a respective one of the top-wall fold lines 168.

In one or more examples, the bottom-wall panels 170 include a first bottom-wall panel 212, a second bottom-wall panel 214, a third bottom-wall panel 216, and a fourth bottom-wall panel 218. When the carton 100 is constructed from the blank 102, the bottom-wall panels 170 form the bottom wall 104 of the carton 100. In other examples, the blank 102 may include more or less than four bottom-wall panels 170, depending, for example, of the shape of the carton 100 formed by the blank 102.

In one or more examples, the first bottom-wall panel 212 extends from and is foldably (e.g., hingedly or movable) connected to the first side-wall panel 204 along a respective one of the bottom-wall fold lines 172. The second bottom-wall panel 214 extends from and is foldably (e.g., hingedly or movable) connected to the second side-wall panel 206 along a respective one of the bottom-wall fold lines 172. The third bottom-wall panel 216 extends from and is foldably (e.g., hingedly or movable) connected to the third side-wall panel 208 along a respective one of the bottom-wall fold lines 172. The fourth bottom-wall panel 218 extends from and is foldably (e.g., hingedly or movable) connected to the fourth side-wall panel 210 along a respective one of the bottom-wall fold lines 172.

One or more of the bottom-wall panels 170 may be coupled to another one of more of the bottom-wall panels 170 by any suitable technique known to those skilled in the art and guided by the teachings provided herein. For example, one or more of the bottom-wall panels 170 may be interlocked with each other, adhesively coupled to each other, taped to each other and combinations thereof. In one or more examples, such as when an adhesive is used to couple the bottom-wall panels 170 together, at least a portion of at least one of the bottom-wall panels 170 may include a coating-free area that facilitates the adhesive bond.

In one or more examples, one or more of the bottom-wall panels 170 (e.g., third bottom-wall panel 216 and fourth bottom-wall panel 218) may include a flap that extends therefrom. The flap may facilitate coupling of a corresponding pair of the bottom-wall panels 170. For example, the flap of one of the bottom-wall panels 170 may engage and be adhesively coupled to the coating-free area of a corresponding one of the bottom-wall panels 170 when the carton 100 is formed from the blank 102.

Generally, each one of the panels 178 of the blank 102 is hingedly movable (e.g., foldable) about a respective one of the fold lines 180 relative to an adjacent one of the panels 178 such that it can move from the orientation shown in a flat or planar configuration (e.g., as shown in FIG. 1) to an orientation shown in a constructed configuration (e.g., as shown in FIGS. 2-4 and 6-8).

Each one of the panels 178 may have any suitable two-dimensional shape and/or any desired dimensions. In the illustrated examples, the panels 178 have an approximately rectangular shape. As such, when the carton 100 is formed from the blank 102, the carton 100 may have any suitable or desired shape, such as an approximately rectangular shape.

In other examples, the blank 102 may include other features or elements that form structural components of the carton 100 formed from the blank 102, such as corner gussets, corner panels, tuck-in panels, connecting flaps (e.g., glue flap 220), and the like.

In one or more examples, the blank 102 is made from a suitable stock material. In one or more examples, the blank 102 is made of paperboard. In one or more examples, the blank 102 is made of cardboard.

In one or more examples, the second surface of the blank 102, forming the exterior surface 158 of the carton 100, is coated (e.g., includes an exterior surface coating). The exterior surface coating may be a waterproof coating, a protective coating, an aesthetic coating, and the like. In one or more examples, at least a portion of the second surface of the blank 102, forming the exterior surface 158 of the carton 100, is printed with the indicia 160 (e.g., as shown in FIG. 4), such as including various product information about the product. For example, the exterior surface 158 of the carton 100 may include branding or other product identification that is easily viewable by the consumer when the carton 100 is displayed and/or stacked.

In one or more examples, the first surface of the blank 102, forming the interior surface 156 of the carton 100, is coated (e.g., includes an interior surface coating). The interior surface coating may be a waterproof coating, a protective coating, an aesthetic coating and the like. For example, the interior surface 156 of the carton 100 may be coted to resist liquid or moisture from the product from weakening or damaging the carton 100.

Referring to FIGS. 1-8, by way of examples, the present disclosure is also directed to a method for forming the carton 100. In one or more examples, the method may include a series of sequential folding operations as described above that rotationally orients the panels 178 of the blank 102 from a flat configuration (e.g., as shown in FIG. 1) to a constructed configuration of the carton 100 (e.g., as shown in FIGS. 2-8). The folding operations are not limited to any particular folding process and may be altered according to particular manufacturing requirements.

In one or more examples, the method includes a step of providing the blank 102. The blank 102 includes the plurality of panels 178 connected along the plurality of fold lines 180. The method includes a step of manipulating the blank 102 such that the panels 178 form the bottom wall 104, the plurality of side walls 106, and the top wall 108 of the carton 100.

In one or more examples, the top-wall panels 166 are releasably coupled together to form the top wall 108 in the closed configuration. The handle 110 is formed by at least a portion of the top wall 108. With the top wall 108 in the closed configuration and the handle 110 in the retracted configuration, the handle 110 and the top wall 108 form the planar surface 112 of the carton 100.

In one or more examples, according to the method, at least a portion of the top wall 108 forms the planar surface 112. The handle 110 of the carton 100 is connected to the top wall 108 and is movable relative to the top wall 108 between the retracted configuration and the deployed configuration. In the retracted configuration, the handle 110 is in a coplanar relationship with the planar surface 112. In the deployed configuration, the handle 110 is in a non-coplanar relationship with the planar surface 112.

In one or more examples, the carton 100 may be erected and formed around the product. In one or more examples, the carton 100 may be partially erected and filled with the product. The erecting and filling process may be performed manually or using a machine in an automated process or a combination thereof.

Referring to FIGS. 1-8, by way of examples, the present disclosure is further directed to a method for packaging product in the carton 100.

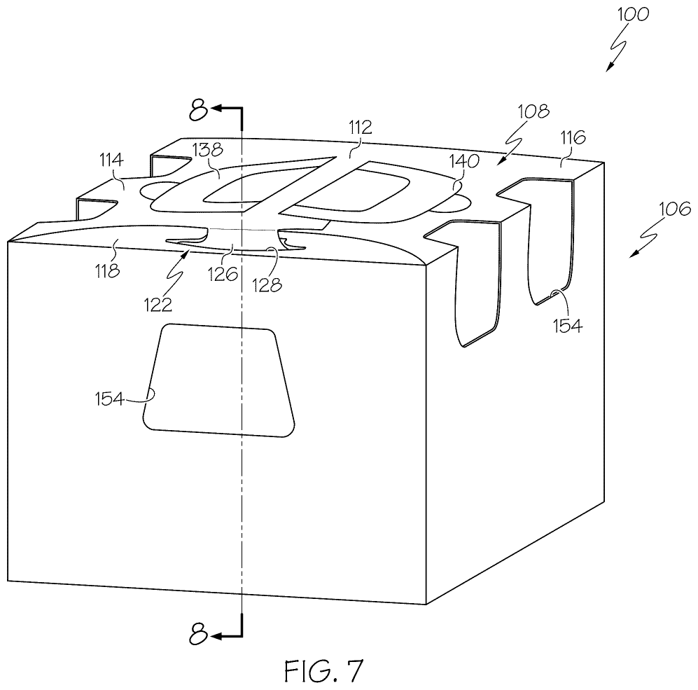

In one or more examples, the method includes a step of partially erecting the carton 100 to form the bottom wall 104 and the plurality of side walls 106 (e.g., as shown in FIG. 6). The method includes a step of loading product into the internal volume 182 of the carton 100. The method includes a step of further erecting the carton 100 to form the top wall 108 (e.g., as shown in FIG. 7).

In one or more examples, according to the method, at least a portion of the top wall 108 forms the planar surface 112. The handle 110 of the carton 100 is connected to the top wall 108 and is in a coplanar relationship with the planar surface 112.

In one or more examples, the method includes a step of stacking the second carton 184 on the planar surface 112 of the carton 100 (e.g., as shown in FIG. 5).

In one or more examples, the carton 100 is self-supporting and facilitates stacking, such as when being shipped, stored, or displayed. The top wall 108 and the handle 110 are supported by the side walls 106 in an approximately horizontal and planar orientation. As such, the planar surface 112, formed by the handle 110 (e.g., in the retracted configuration) and the top wall 108 (e.g., in the closed configuration), enable one carton 100 (e.g., the second carton 184) to be stacked in a vertical arrangement on top of another carton 100.

As an example, a plurality of cartons 202 are shown in FIG. 5 in which each one of the cartons 202 is stacked on another one of the cartons 202 such that the bottom wall 104 of an above one of the cartons 202 (e.g., second carton 184) is in substantially flush contact with (e.g., is substantially coplanar with) the handle 110 and the top wall 108 of a below one of the cartons 202 (e.g., carton 100). The overlapping configuration and intercoupling of the top-wall panels 166, forming the top wall 108, and provides structural integrity to each one of the cartons 202 when the plurality of cartons 202 is stacked.

Generally, each one of the stacked plurality of cartons 202 is the substantially the same. For example, the second carton 184 includes substantially the same features, elements, components, and/or functions as the carton 100 described herein and illustrated in FIGS. 2-4 and 6-8.

In one or more examples, the method includes a step of moving the handle 110 relative to the top wall 108 such that the handle 110 is in a non-coplanar relationship with the planar surface 112 (e.g., as shown in FIG. 2).

The disclosed carton 100 provides a minimal-material solution, with comparable performance (e.g., integrity and market) to a conventional product container. The various examples of the disclosed carton 100 formed from the blank 102 include the handle 110, thereby enabling the carton 100 to serve as a product carrier. In one or more examples, in the retracted configuration, the handle 110 is integral to the top wall 108 and forms a portion of the planar surface 112.

Generally, the blank 102 may be made of a sheet of suitable stock material, such as from a sheet of suitable substrate. It is to be understood that, as used herein, the term “suitable substrate” includes all manner of foldable sheet material, such as paperboard, corrugated board, cardboard, plastic, combinations thereof, and the like. It should be recognized that one or other numbers of blanks may be employed, where suitable, for example, to provide the structure for the carton 100. The blank 102 may be cut (e.g., die cut) from the sheet of stock material.

In one or more examples, the stock material is a cellulosic material, such as paperboard, cardboard, or other heavy-duty paper-based material. In one or more examples, the stock material is polymeric material, such as plastic board (e.g., plastic cardboard) or sheet plastic. In one or more examples, the stock material is made of corrugated board (e.g., cellulosic or polymeric), such as corrugated board that includes two liner sheets and an inner fluted corrugated material sandwiched between and coupled to the liner sheets.

In other examples, the carton 100 and/or the blank 102 (e.g., used to form the carton 100) is formed from a paperboard or corrugated board substrate. The substrate may be, for example, a solid bleached sulfate (SBS) substrate, an uncoated natural kraft (UNC) substrate, or a coated natural kraft (CNK) substrate. The substrate may be formed from virgin fibers, recycled fibers, or combinations thereof.

In one or more examples, the sheet material may be made of or coated (e.g., the surface coating described herein above) with materials to increase its strength. It should be noted that tear-resistant materials, moisture or water-resistant materials, and the like may be provided by more than one layer, to help improve the tear-resistance and/or liquid resistance. Typically, one surface of the sheet material may have different characteristics to the other surface. For example, a portion of the surface of the sheet material that faces outwardly may be particularly smooth and may have a coating such as a clay coating or other surface treatment to provide good printability (e.g., for the indicia 160). A portion of the surface of the sheet material that faces inwardly may, on the other hand, be provided with a coating, a layer, a treatment or be otherwise prepared to provide properties such as one or more of tear-resistance, good glue-ability, heat sealability, food contact, or other desired functional properties.

In one or more examples, use of the cellulosic material to form the carton 100 provides sufficient strength to hold, ship, and display various types of product. Additionally, the cellulosic material is also easily and economically recyclable. Further, the use of the cellulosic material enables the carton 100 (e.g., the blanks 102 used to form the carton 100) to be quickly and easily made, as well as quickly and easily modified to accommodate different styles (e.g., size, shape and configuration). Moreover, cutting and folding machinery for forming cellulosic blanks and cellulosic cartons from blanks are well known.

As used herein, the terms “hinged connection” and “fold line” refer to all manner of lines that define hinge features of a blank, facilitate folding portions of the blank with respect to one another, or otherwise indicate optimal panel folding locations for the blank. Any reference to “hinged connection” should not be construed as necessarily referring to a single fold line only; indeed, a hinged connection can be formed from two or more fold lines, wherein each of the two or more fold lines may be either straight/linear or curved/curvilinear in shape. When linear fold lines form a hinged connection, they may be disposed parallel with each other or be slightly angled with respect to each other. When curvilinear fold lines form a hinged connection, they may intersect each other to define a shaped panel within the area surrounded by the curvilinear fold lines. A typical example of such a hinged connection may include a pair of arched or arcuate fold lines intersecting at two points such that they define an elliptical panel therebetween. A hinged connection may be formed from one or more linear fold lines and one or more curvilinear fold lines. A typical example of such a hinged connection may include a combination of a linear fold line and an arched or arcuate fold line which intersect at two points such that they define a half moon-shaped panel therebetween.

As used herein, the term “fold line” may refer to one of the following: a scored line, an embossed line, a debossed line, a line of perforations, a line of short slits, a line of half-cuts, a single half-cut, an interrupted cutline, a line of aligned slits, a line of scores and any combination of the aforesaid options.

It should be understood that hinged connections and fold lines can each include elements that are formed in the substrate of the blank including perforations, a line of perforations, a line of short slits, a line of half-cuts, a single half-cut, a cutline, an interrupted cutline, slits, scores, embossed lines, debossed lines, any combination thereof, and the like. The elements can be dimensioned and arranged to provide the desired functionality. For example, a line of perforations can be dimensioned or designed with degrees of weakness to define a fold line and/or a severance line. The line of perforations can be designed to facilitate folding and resist breaking, to facilitate folding and facilitate breaking with more effort, or to facilitate breaking with little effort.

The preceding detailed description refers to the accompanying drawings, which illustrate specific examples of the disclosed carton 100, blank 102, and methods described by the present disclosure. It will be understood that the disclosed examples are merely exemplary embodiments of the way in which certain aspects of the invention can be implemented and do not represent an exhaustive list of all of the ways the invention may be embodied. Other examples having different structures and operations do not depart from the scope of the present disclosure.

Well-known components, materials or methods are not necessarily described in detail in order to avoid obscuring the present disclosure. Any specific structural and functional details disclosed herein are not meant to be interpreted as limiting, but merely as a basis for the claims and as a representative basis for teaching one skilled in the art to variously employ the invention.

Like reference numerals may refer to the same feature, element, or component in the different drawings. The figures are not necessarily to scale and some features may be exaggerated or minimized to show details of particular components.

Throughout the present disclosure, any one of a plurality of items may be referred to individually as the item and a plurality of items may be referred to collectively as the items. Moreover, as used herein, a feature, element, component or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

It is to be understood that not necessarily all objects or advantages may be achieved in accordance with any particular example described herein. Thus, for example, those skilled in the art will recognize that certain examples may be configured to operate in a manner that achieves or optimizes one advantage or group of advantages as taught herein without necessarily achieving other objects or advantages as may be taught or suggested herein.

Examples of the disclosed carton 100 and blank 102 for making the same are described above in detail. The blank 102 and the carton 100 are not limited to the specific examples described herein, but rather, components, elements, and/or features of the blanks and/or the containers may be utilized independently and separately from other components, elements, and/or features described herein. For example, the blanks may also be used in combination with other type of product and is not limited to practice with only the articles as described and illustrated herein. Rather, the exemplary embodiment can be implemented and utilized in connection with many other applications.

Conditional language such as, among others, “can” or “may,” unless specifically stated otherwise, are otherwise understood within the context as used in general to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without user input or prompting, whether these features, elements and/or steps are included or are to be performed in any particular example.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

It should be appreciated that, when used to modify a structure, an element, an item, a component or a feature described herein, the terms “front,” “back,” “rear,” “bottom,” “top,” “left,” “right,” “side,” “end,” “upper,” “lower,” “inner,” “outer,” “interior,” “exterior,” as well as similar terms or other forms of such terms, are relative and refer to an example of a spatial relationship between structures, elements, items, components or features. As such, examples of the blanks and the cartons, described herein and illustrated in the figures, are not intended to be limited by the specific relative terms used to describe any structure, element, item, component or feature thereof.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

For the purpose of this disclosure, the terms “coupled,” “coupling,” and similar terms refer to two or more elements that are joined, linked, fastened, attached, connected, put in communication, or otherwise associated with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, relative terms referring to an orientation of an item, such as horizontal, vertical, perpendicular, parallel, and the like terms or variations of such terms, include approximates of such terms. As examples, the term horizontal includes approximately horizontal, substantially horizontal, and exactly horizontal, the term perpendicular includes approximately perpendicular, substantially perpendicular, and exactly perpendicular, etc.

As used herein, the term “substantially” refers to a condition that is essentially the stated condition that performs the desired function or achieves the desired result. As used herein, the term “approximately” refers to a condition that is close to the stated condition, but not exactly, the stated condition that still performs the desired function or achieves the desired result, such as within approximately 10 percent of the stated condition. However, use of the terms “substantially” and “approximately” do not exclude a condition that is exactly the stated condition.

Those skilled in the art will appreciate that not all elements described and illustrated in FIGS. 1-8 need be included in every example and not all elements described herein are necessarily depicted in each illustrative example. FIGS. 1-8, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-8, referred to above, need be included in every example and not all elements, features, and/or components described herein are necessarily depicted in each illustrative example. Accordingly, some of the elements, features, and/or components described and illustrated in FIGS. 1-8 may be combined in various ways without the need to include other features described and illustrated in FIGS. 1-8, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-8, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-8, and such elements, features, and/or components may not be discussed in detail herein with reference to each of FIGS. 1-8. Similarly, all elements, features, and/or components may not be labeled in each of FIGS. 1-8, but reference numerals associated therewith may be utilized herein for consistency.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the carton 100, the blank 102 for forming the carton 100, and methods have been shown and described, modifications may occur to those skilled in the art upon reading the specification. The present application includes such modifications and is limited only by the scope of the claims.

What is claimed is:

1. A carton for packaging product, the carton comprising:
a bottom wall;
a plurality of side walls, connected to the bottom wall;
a top wall, connected to the side walls; and
a handle, connected to the top wall and movable relative to the top wall between a retracted configuration and a deployed configuration,
wherein:
at least a portion of the top wall forms a planar surface;
in the retracted configuration, the handle is in a coplanar relationship with the planar surface; and
in the deployed configuration, the handle is in a non-coplanar relationship with the planar surface.

2. The carton of claim 1, wherein:
the top wall comprises:
a first top-wall panel; and
a second top-wall panel, opposite the first top-wall panel;
the first top-wall panel and the second top-wall panel are movable relative to the side walls between an open configuration and a closed configuration; and
in the closed configuration, a portion of the first top-wall panel overlaps a portion of the second top-wall panel.

3. The carton of claim 2, wherein, in the closed configuration, at least a portion of the first top-wall panel and at least a portion of the second top-wall panel form the planar surface.

4. The carton of claim 2, wherein:
the top wall further comprises:
a third top-wall panel; and
a fourth top-wall panel, opposite the third top-wall panel;
the third top-wall panel and the fourth top-wall panel are movable relative to the side walls between the open configuration and the closed configuration;
in the closed configuration, a portion of the first top-wall panel and a portion of the second top-wall panel overlap a portion of the third top-wall panel; and
in the closed configuration, a portion of the first top-wall panel and a portion of the second top-wall panel overlap a portion of the fourth top-wall panel.

5. The carton of claim 4, wherein, in the closed configuration, at least a portion of the first top-wall panel, at least a portion of the second top-wall panel, at least a portion of the third top-wall panel, and at least a portion of the fourth top-wall panel form the planar surface.

6. The carton of claim 4, further comprising:
a first locking feature that couples the first top-wall panel and the second top-wall panel to the third top-wall panel in the closed configuration; and
a second locking feature, opposite the first locking feature, that couples the first top-wall panel and the second top-wall panel to the fourth top-wall panel in the closed configuration.

7. The carton of claim 6, wherein:
the first locking feature comprises a first locking tab, connected to the first top-wall panel, and a first locking aperture, formed in the third top-wall panel;
the second locking feature comprises a second locking tab, connected to the first top-wall panel opposite the first locking tab, and a second locking aperture, formed in the fourth top-wall panel;
at least a portion of the first locking tab is received by and is secured in the first locking aperture; and
at least a portion of the second locking tab is received by and is secured in the second locking aperture.

8. The carton of claim 7, wherein:
the first locking feature further comprises a third locking tab, connected to the second top-wall panel;
the second locking feature further comprises a fourth locking tab, connected to the second top-wall panel opposite the third locking tab;
at least a portion of the first locking tab overlaps at least a portion of the third locking tab;
at least a portion of the second locking tab overlaps at least a portion of the fourth locking tab;
at least a portion of the third locking tab is received by and is secured in the first locking aperture; and
at least a portion of the fourth locking tab is received by and is secured in the second locking aperture.

9. The carton of claim 2, wherein the handle comprises:
a first handle, connected to and hingedly movable relative to the first top-wall panel between the retracted configuration and the deployed configuration; and
a second handle, connected to and hingedly movable relative to the second top-wall panel between the retracted configuration and the deployed configuration.

10. The carton of claim 9, wherein:
the first handle is connected to the first top-wall panel along a first-handle first fold line, a first-handle second fold line, and a first-handle perforated line;
the second handle is connected to the second top-wall panel along a second-handle first fold line, a second-handle second fold line, and a second-handle perforated line;
the first handle is separable from the first top-wall panel along the first-handle perforated line to move the first handle from the retracted configuration to the deployed configuration; and
the second handle is separable from the second top-wall panel along the second-handle perforated line to move the second handle from the retracted configuration to the deployed configuration.

11. The carton of claim 1, further comprising at least one opening formed in at least one of the side walls.

12. The carton of claim 1, wherein the carton is erected from a blank of a stock material.

13. The carton of claim 12, wherein the stock material comprises paperboard.

14. The carton of claim 12, wherein the stock material comprises cardboard.

15. The carton of claim 1, further comprising an interior surface, wherein at least a portion of the interior surface comprises a surface coating.

16. The carton of claim 1, further comprising an exterior surface, wherein at least a portion of the exterior surface comprises a surface coating.

17. The carton of claim 16, wherein at least a portion of the exterior surface comprises indicia.

18. A blank for forming the carton of claim 1.

19. A blank for forming a carton, the blank comprising:
a plurality of side-wall panels, connected along a plurality of side-wall fold lines;
a plurality of top-wall panels, connected to the side-wall panels along a plurality of top-wall fold lines;
a plurality of bottom-wall panels, connected to the side-wall panels along a plurality of bottom-wall fold lines;
a first handle, connected to a first top-wall panel of the top-wall panels along a first-handle first fold line and a first-handle second fold line; and
a second handle, connected to a second top-wall panel of the top-wall panels along a second-handle first fold line and a second-handle second fold line,
wherein:
the first handle is hingedly movable about the first-handle first fold line and the first-handle second fold line relative to the first top-wall panel; and
the second handle is hingedly movable about the second-handle first fold line and the second-handle second fold line relative to the second top-wall panel.

20. The blank of claim 19, wherein, when the carton is formed from the blank:
the bottom-wall panels form a bottom wall of the carton;
the side-wall panels form a plurality of side walls of the carton;
the top-wall panels form a top wall of the carton;
at least a portion of the top wall forms a planar surface; and
the first handle and the second handle are in a coplanar relationship with the planar surface.

21. The blank of claim 20, wherein, when the carton is formed from the blank, the first handle and the second handle are hingedly movable to a non-coplanar relationship with the planar surface.

22. The blank of claim 19, wherein:
the first handle is connected to the first top-wall panel along a first-handle perforated line;
the second handle is connected to the second top-wall panel along a second-handle perforated line;
the first handle is separable from the first top-wall panel along the first-handle perforated line; and
the second handle is separable from the second top-wall panel along the second-handle perforated line.

23. The blank of claim 19, wherein, when the carton is formed from the blank, the top-wall panels are hingedly movable relative to the side-wall panels between an open configuration and a closed configuration.

24. The blank of claim 23, wherein, when the carton is formed from the blank, a portion of the first top-wall panel overlaps a portion of the second top-wall panel.

25. The blank of claim 23, further comprising a first locking feature and a second locking feature that are configured to releasably couple the top-wall panels together in the closed configuration.

26. The blank of claim 19, further comprising at least one opening formed in at least one of the side-wall panels.

27. The blank of claim 19, comprising paperboard.

28. The blank of claim 19, comprising cardboard.

29. A method for forming a carton, the method comprising:
manipulating a blank such that a plurality of panels forms a bottom wall, a plurality of side walls, and a top wall of the carton,
wherein:
at least a portion of the top wall forms a planar surface;
a handle of the carton is connected to the top wall and is movable relative to the top wall between a retracted configuration and a deployed configuration;
in the retracted configuration, the handle is in a coplanar relationship with the planar surface; and
in the deployed configuration, the handle is in a non-coplanar relationship with the planar surface.

30. A method for packaging product in a carton, the method comprising:
partially erecting the carton to form a bottom wall and a plurality of side walls;
loading product into an internal volume of the carton; and
further erecting the carton to form a top wall,
wherein:
at least a portion of the top wall forms a planar surface; and
a handle of the carton is connected to the top wall and is in a coplanar relationship with the planar surface.

31. The method of claim 30, further comprising stacking a second carton on the planar surface of the carton.

32. The method of claim 30, further comprising moving the handle relative to the top wall such that the handle is in a non-coplanar relationship with the planar surface.
